(19) United States
(12) Patent Application Publication
(10) Pub. No.: US 2025/0205658 A1
(43) Pub. Date: Jun. 26, 2025

(54) POWER REDUCTION MEMBRANE PROCESSES

(71) Applicant: Membrane Technology and Research, Inc., Newark, CA (US)

(72) Inventor: Johannes Gerard Wijmans, Newark, CA (US)

(73) Assignee: Membrane Technology and Research, Inc., Newark, CA (US)

(21) Appl. No.: 18/851,923

(22) PCT Filed: Mar. 31, 2022
(86) PCT No.: PCT/US2022/022874

§ 371 Date: Sep. 27, 2024

(51) Int. Cl. B01F 25/314; B01F 23/10; C10L 3/10

(52) U.S. Cl. CPC B01F 25/31421; B01F 23/19; C10L 3/10

(57) ABSTRACT

A low-power process for combining a first, lower pressure gas stream with a second, higher pressure gas stream employs a membrane device. The first and second gas streams are permeated in the device's permeation membrane, which facilitates net permeation flow from the first gas stream to the second gas stream. A low pressure stream and a separate high pressure stream are discharged from the membrane device after permeating. The low pressure stream has a flow rate less than that of the first stream and the high pressure stream has a flow rate greater than that of the second stream. Because of the membrane permeation, the low pressure stream can be combined with the high pressure stream using less compression power than would be required for direct compression of the first gas stream into the second.

### FIELD OF THE DISCLOSURE

The present disclosure generally relates to gas processing and membrane gas permeation, and more specifically, to the use of gas selective membranes to reduce the amount of gas compression required.

### BACKGROUND

It is generally known in the art that differences in partial pressures between two gas streams represent chemical potential differences, and thus, represent a difference in potential energy. This potential energy is lost when the two gas streams are combined in a bulk mixing step, but energy can be recovered by mixing the two gas streams in a reversible process such as permeation through selective gas separation membranes. In this way, power can be produced from a gas mixing process.

Compression of gas streams typically requires considerable amounts of power and expensive compression equipment. There is a long-standing interest in process improvements that reduce the need to compress gas streams prior to combination of two gas streams. The present disclosure provides a process for applications where two gas streams are to be combined at a pressure higher than the lower pressure of the two gas streams.

### SUMMARY

In one aspect, a process for the reduction of power required to combine a first gas stream at a first pressure with a second gas stream at a second pressure higher than the first pressure, thereby producing a combined third gas stream at a third pressure that is higher than the first pressure, comprises (a) contacting at least part of the first gas stream and at least part of the second gas stream in a membrane device. The membrane device comprises a first inlet port for the first gas stream, a second inlet port for the second gas stream, and first and second outlet ports, wherein the first and second gas streams are separated from one another by a gas permeable membrane, wherein the gas permeable membrane has gas permeation characteristics such that a net permeation flow is created from the first gas stream at the first pressure to the second gas stream at the second pressure, wherein the membrane device produces a high pressure exit stream and a low pressure exit stream. (b) The low pressure exit stream is discharged from the first outlet port of the membrane device. The low pressure exit stream has a flow rate lower than an inlet flow rate of the first gas stream into the membrane device. (c) The low pressure exit stream is combined with any remaining portion of the first gas stream, and the low pressure combined stream is compressed to the third pressure. (d) The high pressure exit stream is discharged from the second outlet port of the membrane device. The high pressure exit stream has a flow rate that is higher than an inlet flow rate of the second gas stream into the membrane device. (e) The high pressure exit stream is combined with any remaining portion of the second gas stream. (f) The compressed low pressure combined stream and the high pressure combined stream are combined to produce the combined third gas stream at the third pressure.

In another aspect, a process for the reduction of power required to combine a first gas stream at a first pressure with a second gas stream at a second pressure. The second pressure is higher than the first pressure, hereby producing a third gas stream at a third pressure higher than the first pressure. The process comprises (a) compressing the first gas stream to an intermediate pressure below the second pressure, and optionally heating or cooling the intermediate gas pressure stream. (b) At least part of the first gas stream at the intermediate pressure and at least part of the second stream are contacted in a membrane device. The membrane device comprises a first inlet port for the first gas stream, a second inlet port for the second gas stream, and first and second outlet ports. The first and second gas streams are separated from one another by a gas permeable membrane. The gas permeable membrane has gas permeation characteristics such that a net permeation flow is created from the first gas stream at the first pressure to the second gas stream at the second pressure. The membrane device produces a high pressure exit stream and an intermediate pressure exit stream. (c) The intermediate pressure exit stream is discharged from the first outlet port of the membrane device. The intermediate pressure exit stream has a flow rate lower than an inlet flow rate of the first gas stream into the membrane device. (d) The intermediate pressure exit stream is combined with any remaining portion of the first gas stream, and the intermediate pressure combined stream is compressed to the third pressure. (e) The high pressure exit stream is discharged from the second outlet port of the membrane device. The high pressure exit stream has a flow rate that is higher than an inlet flow rate of the second gas stream into the membrane device. (f) The high pressure exit stream is combined with any remaining portion of the second gas stream. (g) The combined intermediate pressure stream and the combined high pressure stream are combined to produce the third gas stream at the third pressure.

In another aspect, a process for combining a first gas stream with a second gas stream comprises imparting a first gas stream at a first pressure and first flow rate into a membrane device. A second gas stream at a second pressure and second flow rate is imparted into the membrane device. The second pressure is greater than the first pressure. The first and second gas streams are permeated in a gas permeation membrane of the membrane device. The gas permeation membrane is configured for net permeation flow from the first gas stream to the second gas stream. A low pressure stream and a separate high pressure stream are discharged from the membrane device after said permeating. The low pressure stream has a third flow rate less than the first flow rate and the high pressure stream has a fourth flow rate greater than the second flow rate. The low pressure stream is compressed to combine the low pressure stream with the high pressure stream.

Other objects and features will be in part apparent and in part pointed out hereinafter.

### DESCRIPTION OF THE DRAWINGS

FIG. 1 is a schematic drawing of a prior art process for combining two gas streams at different pressures.

FIG. 2 is a schematic drawing of a process according to the present disclosure for combining two gas streams at different pressures.

FIG. 3 is a plot of compressor power versus installed membrane area for certain processes.

FIG. 4 is a plot of the five-year cumulative savings versus installed membrane area for certain processes.

FIG. 5 is a plot of the compressor power versus installed membrane area for certain processes.

FIG. 6 is a plot of the compressor power versus installed membrane area for certain implementations of the process illustrated in FIG. 7.

FIG. 7 is a schematic drawing of another embodiment of a process according to the present disclosure for combining two gas streams at different pressures.

FIG. 8 is a plot of the compressor power versus installed membrane area for certain processes.

FIG. 9 is a schematic drawing of another embodiment of a process according to the present disclosure for combining two gas streams at different pressures.

FIG. 10 is a plot of the compressor power versus installed membrane area for certain processes.

FIG. 11 is a schematic drawing of another embodiment of a process according to the present disclosure for combining two gas streams at different pressures.

FIG. 12 is a plot of compressor power minus turbine power versus installed membrane area for certain processes.

Corresponding reference characters indicate corresponding parts throughout the drawings.

### DETAILED DESCRIPTION

A key feature of membrane gas permeation is that the permeation rate of each individual gas component is driven by the difference in component partial pressure across the membrane and is not driven by the difference in total pressure. This makes it possible to permeate one or more gas components from a lower pressure gas stream to a higher pressure gas stream, if the component partial pressure in the lower pressure stream is higher than the component partial pressure of the higher pressure stream. Depending on the composition of the two gas stream, and with proper selection of the membrane used, as will be described herein, it is possible to achieve a net flow from the lower pressure gas stream to the higher pressure gas stream. The reduction in flow rate of the lower pressure gas stream reduces the amount of power required for subsequent compression of the lower pressure gas stream.

The permeation flow rate F of a gas component i through a gas separation membrane is given by the following equation:

$${F}_{i} = {A}_{m} \cdot \frac{{P}_{m , i}}{1} \cdot ( {p}_{i}^{a} - {p}_{i}^{b} ) = {A}_{m} \cdot \frac{{P}_{m , i}}{1} \cdot ( {x}_{i}^{a} \cdot {P}^{a} - {x}_{i}^{b} \cdot {P}^{b} )$$

wherein Aₘ is the membrane area, P_{m,i}/ι is the membrane permeance, P_{m,i} is the membrane permeability, ι is the thickness of the membrane, and (pᵢ^{a}-pᵢ^{b}) is the partial pressure difference between the two streams a, b that are separated by the membrane. In non-ideal systems, the partial pressure difference has to be replaced by the fugacity difference; however, for the analysis presented herein, this does not necessarily make a material difference. The partial pressures in each stream are the product of the molar fraction x and the total pressure P.

The gas component i permeates from stream a to stream b when the partial pressure of component i is higher in stream a than in stream b. This is true even if the total pressure of stream a, P^{a}, is lower than the total pressure of stream b, P^{b}, in which case component i permeates through the membrane from a lower total pressure stream to a higher total pressure stream. This particular situation exists when

xᵢ^{a}/xᵢ^{b}>P^{b}/P^{a}

When component i is present in the lower pressure stream and has a high membrane permeance compared to at least one other gas component j present in the high pressure stream, then it is possible for the combined permeation flow rate of all components to be in the direction from the low pressure stream to the high pressure stream.

The selectivity αⁱⱼ of the membrane for component i over component j is defined as:

$${α}_{j}^{i} = \frac{{P}_{i} / 1}{{P}_{j} / 1} = \frac{{P}_{i}}{{P}_{j}}$$

The requirement for the membrane is thus that it is a gas separation membrane with a selectivity for component i over j, generally substantially larger than one.

Moussaddy et al. describe a process to generate power by permeating part of a waste gas stream such as power plant flue gas with air. An air stream is compressed and is brought into contact with one side of a gas selective membrane. Thus, flue gas consisting mostly of nitrogen but also containing carbon dioxide is brought into contact with the other side of the membrane at atmospheric pressure. The membrane is selective for carbon dioxide over nitrogen. Carbon dioxide permeates from the flue gas stream to the compressed air stream, thereby increasing the flow rate of that stream. This stream is then sent to a turbine in which the stream is expanded to atmospheric pressure. The turbine has the potential to produce more power than is required to run the air compressor because the flow rate to the turbine exceeds the flow rate to the compressor. The net power generated by the process is the power produced by the turbine minus the power required for the initial air compressor. The power densities reported by Moussaddy are below 1 W/m² membrane area.

The process described herein does not produce power but makes use of the partial pressure permeation principles described above to reduce the compressor capacity and power required to combine two gas streams into a third gas stream above atmospheric pressure.

An exemplary process where this concept is applied is the addition of hydrogen to natural gas pipelines, typically to a level of about 20% hydrogen. One objective of adding hydrogen to natural gas is to reduce carbon emissions when the gas is burned, making the natural gas a “greener” fuel. Another objective is to use the existing natural gas pipelines to transport hydrogen and to carry out downstream separation and purification of the hydrogen as required by hydrogen users. Hydrogen is typically produced via the steam-methane reforming process at a pressure of from about 10 to about 30 atm. The natural gas pipeline pressure is typically from about 50 to about 150 at.

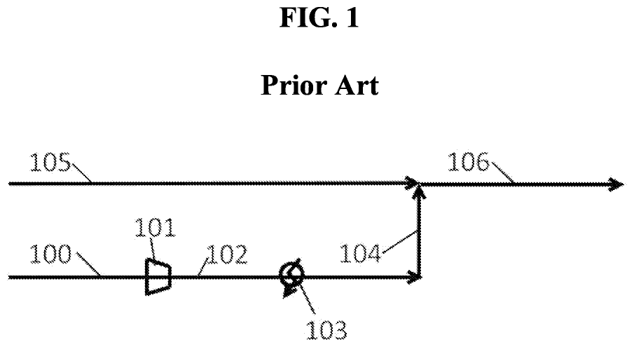

FIG. 1 (described above) illustrates the traditional approach in which hydrogen is compressed to the pressure of the natural gas stream and the two streams are combined.

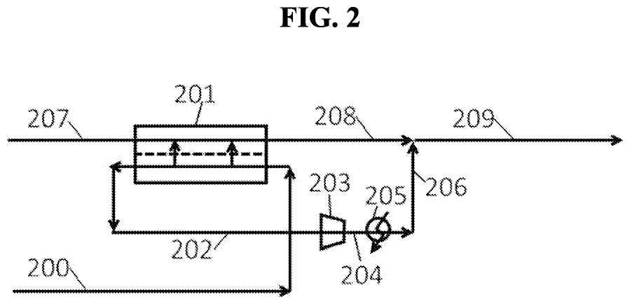

In contrast, FIG. 2 applies the principles described herein and illustrates a flow diagram for an exemplary embodiment of a process for combining a first gas stream 200 of a first pressure with a second gas stream 207 of a greater pressure in order to produce a combined third gas stream 209 (the product of the process) at a third pressure that is also greater than the first pressure. In the process of FIG. 2, at least part of the first gas stream 200 contacts at least part of the second gas stream 207 in a membrane device 201. The illustrated membrane device 201, shown schematically, comprises a first inlet port for the first gas stream 200, a second inlet port for the second gas stream 207, a first outlet port for a low pressure exit stream 202, and a second outlet port for a high pressure exit stream 208. In the membrane device 201, the first and second gas streams 200, 207 are separated from one another by a gas permeable membrane. The gas permeable membrane has gas permeation characteristics such that a net permeation flow is created from the first gas stream 200 at the first pressure to the second gas stream 207 at the greater second pressure. Accordingly, the membrane device 201 discharges the low pressure exit stream 202 through the first outlet at a flow rate less than the flow rate at which the first gas stream 200 enters the membrane device and discharges the high pressure exit stream 208 through the second outlet at a flow rate greater than the flow rate at which the second gas stream 207 enters the membrane device.

Once discharged from the membrane device 201, the high pressure exit stream 208 is combined with any remaining portion of the second gas stream 207. In some instances, the high pressure exit stream 207 may be compressed or expanded to the desired third pressure for the combined product gas stream 209 of the process. Similarly, once the low pressure exit stream 202 is discharged from the membrane device 201, the low pressure exit stream 202 is combined with any remaining portion of the first gas stream 201, and then a compressor 203 compresses the stream 202, making a compressed stream 204 at the third pressure desired for the combined third gas stream product 209. An optional heat exchanger 205 can cool the compressed stream 204 to form a cooled compressed stream 206 for mixing. At this stage of the process, the cooled/compressed low pressure exit stream 206 and the high pressure exit stream 208 have about the same (third) pressure, and therefore can be mixed to form the combined product gas stream 209.

Because the flow rate of the low pressure exit stream 207 is reduced in relation to the flow rate of the first gas stream 200, the size of the compressor 203 needed to bring the low pressure exit stream up to mixing pressure is reduced, which in turn reduces both the capital and operating cost of the compressor required for the mixing process as compared with the compressor 105 of the conventional mixing process of FIG. 1. When all other inputs to the process are kept the same, the power reduction of the process of FIG. 2 over the process of FIG. 1 per unit area of the gas permeation membrane is at least about 10 W/m2, at least about 20 W/m2, at least about 50 W/m2, at least about 100 W/m2, or from about 10 W/m2 to about 200 W/m2.

As a specific example, prior to compression, a hydrogen stream is brought into contact with one side of an appropriate gas selective membrane which has a high selectivity for hydrogen over methane (the main component of natural gas). The natural gas stream is at a higher total pressure than the hydrogen stream and is brought into contact with the other side of the membrane. The partial pressure differences between the two gas streams drive hydrogen to permeate into the natural gas stream and drive methane to permeate into the hydrogen stream. However, because the membrane is more permeable to hydrogen vs. methane, the combined net permeation flow is from the lower pressure hydrogen stream to the higher pressure natural gas stream. This reduces the flow rate of the low pressure hydrogen stream to the compressor and reduces the capacity and power required for the compressor. This process is very efficient and can achieve reductions in compression power in excess of 100 W/m² membrane area. The savings provided by the process consist not just of the reduction in power consumption but also in the reduced capital cost associated with utilization of a smaller compressor. The combined savings are typically more than sufficient to cover the capital cost of the membrane system.

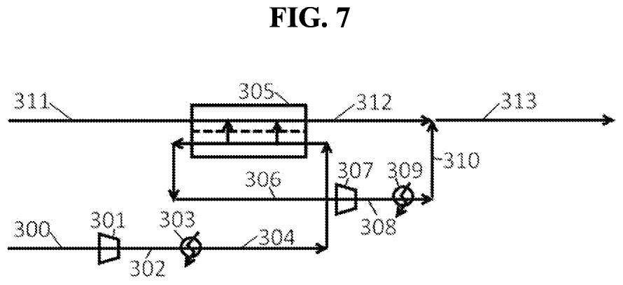

FIG. 7 illustrates another embodiment of a process for combining a first gas stream 300 of a first pressure with a second gas stream 311 of a greater pressure in order to produce a combined third gas stream 313 (the product of the process) at a third pressure that is also greater than the first pressure. The process of FIG. 7 differs from the process of FIG. 2 in that a first compressor 301 compresses the first gas stream 300 to be an intermediate gas pressure stream 302 at an intermediate gas pressure greater than the first pressure but less than the second pressure. An optional heat exchanger 303 cools the intermediate gas pressure stream 302 to make a cooled intermediate gas pressure stream 304.

In the process of FIG. 7, at least part of the intermediate gas pressure stream 304 contacts at least part of the second gas stream 311 in a membrane device 305. The illustrated membrane device 305, shown schematically, comprises a first inlet port for the intermediate gas pressure stream 304, a second inlet port for the second gas stream 311, a first outlet port for an intermediate pressure exit stream 306, and a second outlet port for a high pressure exit stream 312. In the membrane device 305, the gas streams 304, 311 are separated from one another by a gas permeable membrane. The gas permeable membrane has gas permeation characteristics such that a net permeation flow is created from the intermediate gas pressure stream 304 at the intermediate gas pressure to the second gas stream 311 at the greater second pressure. Accordingly, the membrane device 305 discharges the low pressure exit stream 306 through the first outlet at a flow rate less than the flow rate at which the gas stream 300 enters the compressor 301 and the flow rate at which the intermediate gas pressure stream 304 enters the membrane device. The membrane device also discharges the high pressure exit stream 312 through the second outlet at a flow rate greater than the flow rate at which the second gas stream 311 enters the membrane device.

Once discharged from the membrane device 305, the high pressure exit stream 312 is combined with any remaining portion of the second gas stream 311. In some instances, the high pressure exit stream 312 may be compressed or expanded to the desired third pressure for the combined product gas stream 313 of the process. Similarly, once the low pressure exit stream 306 is discharged from the membrane device 305, the low pressure exit stream 306 is combined with any remaining portion of the first gas stream 300, and then a second compressor 307 compresses the stream, making a compressed stream 308 at the third pressure desired for the combined gas stream product 313. An optional heat exchanger 309 can cool the compressed stream 308, making a cooled compressed gas stream 310 for mixing. At this stage of the process, the cooled/compressed low pressure exit stream 310 and the high pressure exit stream 312 have about the same (third) pressure, and therefore can be mixed to form the combined product gas stream 313.

Because the flow rate of the low pressure exit stream 306 is reduced in relation to the flow rate of the first gas stream 300, the size of the compressors 301, 307 needed to bring the stream up to mixing pressure is reduced, which in turn reduces both the capital and operating cost of the compressor required for the mixing process as compared with the compressor 105 of the conventional mixing process of FIG. 1. When all other inputs to the process are kept the same, the power reduction of the process of FIG. 7 over the process of FIG. 1 per unit area of the gas permeation membrane is at least about 10 W/m2, at least about 20 W/m2, at least about 50 W/m2, at least about 100 W/m2, or from about 10 W/m2 to about 200 W/m2.

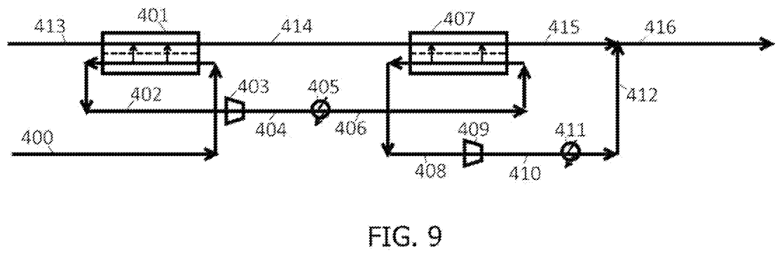

FIG. 9 illustrates another embodiment of a process for combining a first gas stream 400 of a first pressure with a second gas stream 413 of a greater pressure in order to produce a combined third gas stream 416 (the product of the process) at a third pressure that is also greater than the first pressure. The process of FIG. 9 differs from the process of FIG. 2 in that two membrane devices 401, 407 are used in series to permeate respective parts of the first gas stream 400 from the low pressure side of the process to the high pressure side of the process before mixing.

In the process of FIG. 9, at least part of the first gas stream 400 contacts at least part of the second gas stream 413 in a membrane device 401. The illustrated membrane device 401, shown schematically, comprises a first inlet port for the first gas stream 400, a second inlet port for the second gas stream 413, a first outlet port for an intermediate low pressure stream 402, and a second outlet port for an intermediate high pressure stream 414. In the membrane device 401, the first and second gas streams 400, 413 are separated from one another by a gas permeable membrane. The gas permeable membrane has gas permeation characteristics such that a net permeation flow is created from the first gas stream 400 at the first pressure to the second gas stream 413 at the greater second pressure. Accordingly, the membrane device 401 discharges the intermediate low pressure stream 402 through the first outlet at a flow rate less than the flow rate at which the first gas stream 400 enters the membrane device and discharges the intermediate high pressure stream 414 through the second outlet at a flow rate greater than the flow rate at which the second gas stream 413 enters the membrane device.

After the intermediate low pressure stream 402 is discharged from the first of the two membrane devices 401, 407, a compressor 403 compresses the stream 402, making a compressed stream 404 at an intermediate pressure greater than the first pressure but less than the second pressure. An optional heat exchanger 405 can cool the compressed stream 404 to form a cooled/compressed intermediate low pressure stream 406.

At least part of the intermediate low pressure stream 406 contacts at least part of the intermediate high pressure stream 414 in a membrane device 407. The membrane device 407, shown schematically, comprises a first inlet port for the intermediate low pressure stream 406, a second inlet port for the intermediate high pressure stream 414, a first outlet port for a low pressure exit stream 408, and a second outlet port for a high pressure exit stream 415. In the membrane device 407, the gas streams 406, 416 are separated from one another by a gas permeable membrane that again has gas permeation characteristics such that a net permeation flow is created from the stream 406 to the stream 414 at a greater pressure. Accordingly, the membrane device 407 discharges the low pressure exit stream 408 through its first outlet at a flow rate less than the flow rate at which the gas stream 406 enters the membrane device 407. The membrane device 407 also discharges the high pressure exit stream 415 through the second outlet at a flow rate greater than the flow rate at which the stream 414 enters the membrane device.

Once discharged from the membrane device 407, the high pressure exit stream 415 is combined with any remaining portion of the second gas stream 413. In some instances, the high pressure exit stream 415 may be compressed or expanded to the desired third pressure for the combined product gas stream 416 of the process. Similarly, once the low pressure exit stream 408 is discharged from the membrane device 407, the low pressure exit stream 408 is combined with any remaining portion of the first gas stream 400, and then a second compressor 409 compresses the stream, making a compressed stream 410 at the third pressure desired for the combined gas stream product 416. An optional heat exchanger 411 can cool the compressed stream 410, making a cooled compressed gas stream 412 for mixing. At this stage of the process, the cooled/compressed low pressure exit stream 412 and the high pressure exit stream 415 have about the same (third) pressure, and therefore can be mixed to form the combined product gas stream 416.

Because the flow rate of each of the streams 402, 408 is reduced in relation to the flow rate of the first gas stream 400, the size of the compressors 403, 409 needed to bring the stream up to mixing pressure is reduced, which in turn reduces both the capital and operating cost of the compressor required for the mixing process as compared with the compressor 105 of the conventional mixing process of FIG. 1. When all other inputs to the process are kept the same, the power reduction of the process of FIG. 7 over the process of FIG. 1 per unit area of the gas permeation membrane is at least about 10 W/m2; in some cases, at least about 20 W/m2, at least about 50 W/m2, at least about 100 W/m2, or from about 10 W/m2 to about 200 W/m2.

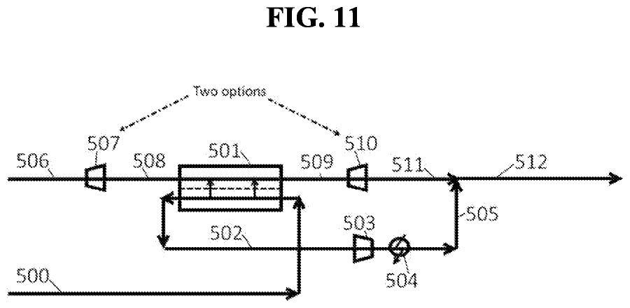

FIG. 11 illustrates still another embodiment of a process for combining a first gas stream 500 of a first pressure with a second gas stream 506 of a greater pressure in order to produce a combined third gas stream 512 (the product of the process) at a third pressure that is also greater than the first pressure. The process of FIG. 11 differs from the process of FIG. 2 in that power is produced by expanding high pressure gas through a 507, 510 at one or more points along the process. The power produced is, in turn, used to power the compressor 503 that brings the low pressure side of the process up to mixing pressure.

In one embodiment of the process of FIG. 11, at least part of the second gas stream 506 is expanded in a turbine 507 to generate power before an expanded second gas stream is imparted into the membrane device 501. The turbine 507 outputs power to the compressor 503. At least part of the first gas stream 500 contacts at least part of the expanded second gas stream 508 in a membrane device 501. The illustrated membrane device 501, shown schematically, comprises a first inlet port for the first gas stream 500, a second inlet port for the expanded second gas stream 508, a first outlet port for a low pressure exit stream 502, and a second outlet port for a high pressure exit stream 509. In the membrane device 501, the first and second gas streams 500, 508 are separated from one another by a gas permeable membrane. The gas permeable membrane has gas permeation characteristics such that a net permeation flow is created from the first gas stream 500 at the first pressure to the second gas stream 508, which even after expansion remains at a greater pressure. Accordingly, the membrane device 501 discharges the low pressure exit stream 502 through the first outlet at a flow rate less than the flow rate at which the first gas stream 500 enters the membrane device and discharges the high pressure exit stream 509 through the second outlet at a flow rate greater than the flow rate at which the second gas stream 508 enters the membrane device.

In one embodiment of the process of FIG. 11, once the high pressure exit stream 509 is discharged from the membrane device 501, the high pressure exit stream 509 is expanded in a turbine 510. Typically only one turbine 507, 510 will be used in the process, not both. If the turbine 510 is used, it outputs power to the compressor 503. The turbine 510 is suitably configured to output a discharge stream 511 may at the desired third pressure for the combined product gas stream 512 of the process.

After the low pressure exit stream 502 is discharged from the membrane device 501, the low pressure exit stream 502 is combined with any remaining portion of the first gas stream 501, and then a compressor 503, drawing power from at least one of the turbines 507, 510, compresses the stream 502, making a compressed stream 505 at the third pressure desired for the combined third gas stream product 512. An optional heat exchanger 505 can cool the compressed stream 505 before mixing. At this stage of the process, the cooled/compressed low pressure exit stream 505 and the discharge stream 511 have about the same (third) pressure, and therefore can be mixed to form the combined product gas stream 512.

Again, because the flow rate of the low pressure exit stream 502 is reduced in relation to the flow rate of the first gas stream 500, the size of the compressor 503 needed to bring the low pressure exit stream up to mixing pressure is reduced, which in turn reduces both the capital and operating cost of the compressor required for the mixing process as compared with the compressor 105 of the conventional mixing process of FIG. 1. The operating costs of the process may be further reduced by using the turbine 507, 510 to power the compressor. The size of the compressor is also further reduced because the second gas stream pressure is reduced by the turbine 507, 510. When all other inputs to the process are kept the same, the power reduction of the process of FIG. 11 over the process of FIG. 1 per unit area of the gas permeation membrane is at least about 10 W/m2, at least about 20 W/m2, at least about 50 W/m2, at least about 100 W/m2, or from about 10 W/m2 to about 200 W/m2.

As the skilled person will understand, a key aspect of the processes shown schematically in FIGS. 2, 7, 9, and 11 is that at least one component of the low pressure gas stream has a high membrane permeance and at least one component of the high pressure gas stream has a low membrane permeance. This effect makes it possible that the net permeation flow, which is the sum of the permeation flow rates of all components, is in the direction from the low pressure gas stream to the high pressure gas stream. In any of the above described processes, the membrane device can operate in a crossflow mode or a countercurrent mode. The membrane device can have a plate-and-frame configuration, a spiral-wound configuration, a hollow-fiber configuration, or any other acceptable configuration known in the art.

Having described the invention in detail, it will be apparent that modifications and variations are possible without departing from the scope of the invention defined in the appended claims.

### EXAMPLES

The following non-limiting examples are provided to further illustrate the present invention. The Examples describe process simulations which were carried out on the CHEMCAD process simulator (available from Chemstations, Houston, TX). All simulations described are for a membrane separation system that operates in a countercurrent sweep mode, but it will be understood that a crossflow sweep mode can also be used. The membrane modules used in the membrane step can have a number of different configurations, including plate-and-frame, spiral-wound, or hollow-fiber configurations.

### Example 1—Conventional Processes

An example of a conventional process is the addition of hydrogen to a natural gas (NG) pipeline. Because hydrogen is typically produced at a pressure below the pressure of the NG pipeline, a compressor is required to compress the hydrogen stream (FIG. 1). In this example, stream 100 represents a hydrogen gas stream at a pressure of 20 atm and with a flowrate of 25 MMscfd. Stream 105 represents a methane gas stream at a pressure f 100 atm and a flowrate of 100 MMscfd. The goal is to create a 125 MMscfd stream at 100 atm containing 80% methane and 20% hydrogen (i.e., stream 106). The conventional approach is to compress the entire hydrogen stream 100 to 100 atm and to subsequently mix the streams 104, 105. The power required for compression of the hydrogen stream 100 is 2.28 MW (two stage compressor, 75% efficiency).

### Example 2

In this Example, the high pressure gas stream consists of 100 MMscfd pure methane at 100 atm, and the low pressure gas stream consists of 25 MMscfd pure hydrogen ta 20 atm (i.e., the same as Example 1). However, in this Example, the process depicted in FIG. 2 and according to the present disclosure is utilized. Thus, the hydrogen stream 200 is sent to the low pressure side of the membrane system 201, and the methane stream 207 is sent to the high pressure side of the membrane system 201. The membrane system 201 contains a gas selective membrane that is positioned between the two streams.

The driving force for methane to permeate through the membrane from stream 207 to the lower pressure gas stream 200 depends on the amount of methane transferred by permeation to stream 200 and on the amount of hydrogen transferred by permeation to stream 207. Assuming the amount of methane permeated is small, the driving force for methane permeation from stream 207 to stream 200 will be in the range of 80 to 100 atm.

The driving force for hydrogen to permeate through the membrane from stream 200 to the higher-pressure gas stream 207 also depends on the amount of methane transferred by permeation to stream 200 and on the amount of hydrogen transferred by permeation to stream 207. Assuming the amount of methane permeated is small, the driving force for hydrogen permeation from stream 200 to steam 207 will be in the range of 0 to 20 atm.

For both hydrogen and methane, the permeation flow equals the driving force times the membrane permeance times the membrane area. To achieve a net permeation flow from the low-pressure stream to the high-pressure stream, the permeation flow of hydrogen has to exceed the permeation flow of methane. The membrane area is the same for both components, so net permeation to the high-pressure side requires a hydrogen permeance that is substantially greater than the methane permeance. Thus, the membrane must have a high hydrogen/methane selectivity, which is defined as the hydrogen permeance divided by the methane permeance. Membranes used commercially for hydrogen separations have hydrogen/methane selectivities in the range of 25 to 100 or even higher.

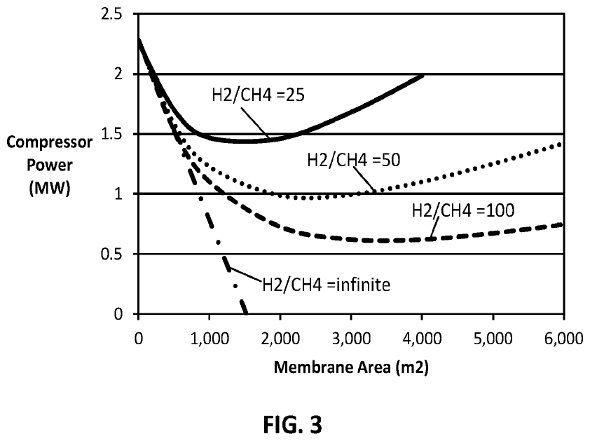

Process simulations were carried out for a membrane with a permeance for hydrogen of 500 gpu and the hydrogen/methane selectivity was varied from 25 to 100. The membrane unit was operated in counter-current mode and the calculated reduction in compressor power is shown in FIG. 3 as a function of the membrane area for four different H₂/CH₄ selectivities of respectively 25, 50, 100 and infinite. Compressor power was calculated for a two-stage compressor at 75% efficiency. Increasing the membrane area decreases the compressor power because more hydrogen permeates to the higher-pressure methane stream. But eventually, the compressor power required starts to increase again because the driving force for hydrogen permeation decreases more rapidly than the driving force for methane. FIG. 3 shows that higher selectivity is advantageous at all membrane areas because a higher selectivity reduces the amount of methane that permeates into stream 200 relative to the amount of hydrogen that permeates into stream 207. The calculated data points are given in Table 1, which also shows that the power savings density can be as high as 1,500 W/m².

TABLE 1
Example 2 Data.

| | H₂ = 500 gpu | | H₂ = 500 gpu | | H₂ = 500 gpu | | H₂ = 500 gpu | |
|---|---|---|---|---|---|---|---|---|
| | CH₄ = 0 gpu | | CH₄ = 5 gpu | | CH₄ = 10 gpu | | CH₄ = 20 gpu | |
| | | Power | | Power | | Power | | Power |
| Membrane | Compr | Savings | Compr. | Savings | Compr. | Savings | Compr. | Savings |
| Area | Power | Density | Power | Density | Power | Density | Power | Density |
| (m²) | (MW) | (W/m²) | (MW) | (W/m²) | (MW) | (W/m²) | (MW) | (W/m²) |
| 0 | 2.28 | | 2.28 | | 2.28 | | 2.28 | |
| 1,000 | 0.78 | 1,500 | 1.10 | 1,180 | 1.23 | 1,050 | 1.47 | 810 |
| 2,000 | | | 0.73 | 780 | 0.99 | 650 | 1.46 | 410 |
| 3,000 | | | 0.62 | 550 | 0.99 | 430 | 1.68 | 200 |
| 4,000 | | | 0.62 | 420 | 1.10 | 300 | 1.99 | 70 |
| 5,000 | | | 0.67 | 320 | 1.25 | 210 | | |
| 6,000 | | | 0.75 | 260 | 1.42 | 140 | | |

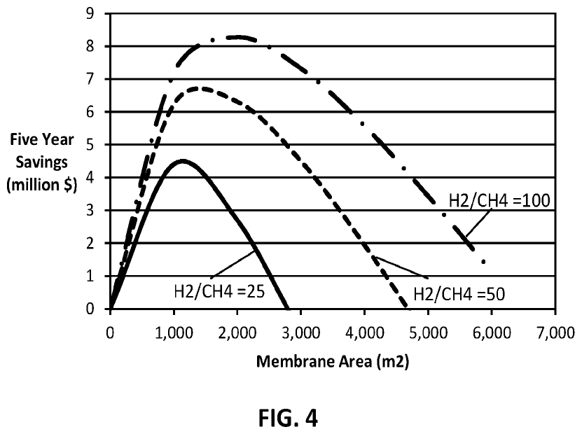

The process for power reduction is very cost effective. FIG. 4 illustrates the five-year savings calculated using an installed cost for the membrane skid of $1000/m², an installed cost for the compressor at $1000/kW, an electrical energy cost of $0.15/kWh and a membrane replacement cost of $150/m²/year. In this calculation, the membrane skid is a capital investment, the reduction in compression capacity is a capital savings, the reduction in compression power is a five-year operating cost savings and membrane replacement is a five-year operating cost. Depending on the membrane hydrogen/methane selectivity, the optimum membrane area is in the range of 1,000 to 3,000 m², whereas many current commercial systems have areas in excess of 5,000 or 10,000 m².

### Example 3

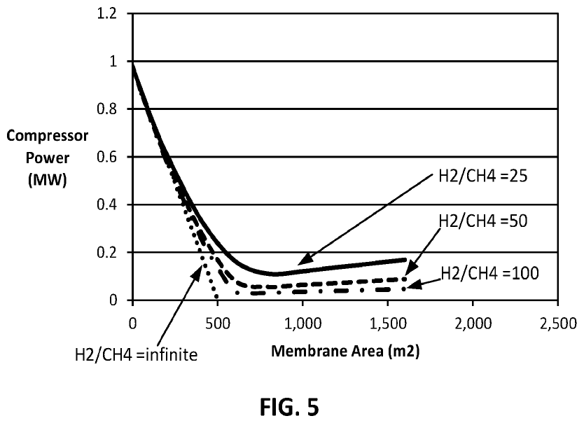

In this Example, the representative hydrogen stream 200 in FIG. 2 is available at 50 atm. All other parameters are identical to those in Example 2. The conventional process of FIG. 1 requires 0.98 MW compression power for these parameters, so the opportunity for power reduction is reduced compared to Example 2. However, FIG. 5 shows that the membrane area required is reduced as well, which is expected as the driving force for hydrogen permeation has increased. As shown in Table 2, the power reduction density has increased to values approaching 2,000 W/m². FIG. 5 also shows that the membrane selectivity can be relatively low. This may allow the use of membranes with higher permeances, which will reduce the membrane area, and thus capital cost, even further and will increase the power reduction density.

TABLE 2
Example 3 Data.

| | H₂ = 500 gpu | | H₂ = 500 gpu | | H₂ = 500 gpu | | H₂ = 500 gpu | |
|---|---|---|---|---|---|---|---|---|
| | CH₄ = 0 gpu | | CH₄ = 5 gpu | | CH₄ = 10 gpu | | CH₄ = 20 gpu | |
| | | Power | | Power | | Power | | Power |
| Membrane | Compr. | Savings | Compr. | Savings | Compr. | Savings | Compr. | Savings |
| Area | Power | Density | Power | Density | Power | Density | Power | Density |
| (m²) | (MW) | (W/m²) | (MW) | (W/m²) | (MW) | (W/m²) | (MW) | (W/m²) |
| 0 | 0.98 | | 0.98 | | 0.98 | | 0.98 | |
| 400 | 0.20 | 1,960 | 0.58 | 1,790 | 0.29 | 1,720 | 0.34 | 1,600 |
| 600 | | | 0.14 | 1,570 | 0.08 | 1,490 | 0.17 | 1,360 |
| 800 | | | 0.03 | 1,180 | 0.06 | 1,150 | 0.11 | 1,090 |
| 1,600 | | | 0.05 | 580 | 0.09 | 560 | 0.17 | 510 |

### Example 4

In this example, the hydrogen stream has a flowrate of 100 MMscfd, is at a pressure of 20 atm and we consider only the membrane with a H₂/CH₄ selectivity of 50. All other parameters are identical to those in Example 2, which means that the final combined gas stream will contain 50% hydrogen and 50% methane. The conventional process of FIG. 1 requires 9.13 MW compression power in this case, so the opportunity for power reduction is increased compared to Examples 2 and 3.

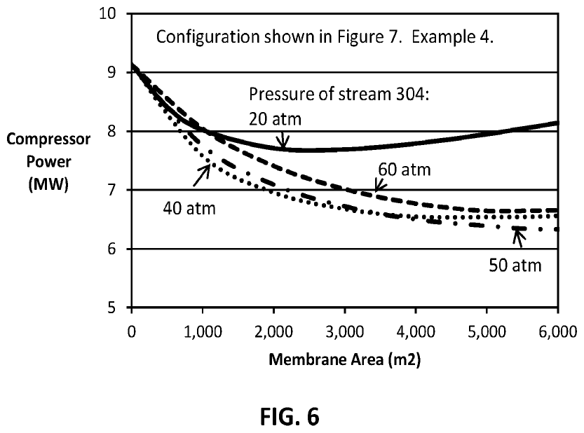

However, FIG. 6 shows that the maximum power reduction achieved is only about 1.5 MW if the flow configuration shown in FIG. 2 is used. The limitation encountered in this example is that the membrane step can achieve only a maximum hydrogen concentration of 20% in the high-pressure stream 208: the partial pressure of hydrogen in the hydrogen stream 200 is 20 atm and the total pressure of the high-pressure stream 208 is 100 atm. The hydrogen concentration in the final combined stream 209 is 50%, so the amount of hydrogen that the membrane step can transfer is at most 40% of the total amount of hydrogen.

This limitation can be overcome by adding a compressor to the flow configuration, as shown in FIG. 7. FIG. 7 illustrates a flow diagram for combining a gas stream 300 with a gas stream 311 at a higher pressure than stream 300 to obtain gas stream 313. The membrane permeances of the membrane in membrane device 305 are such that a net permeation flow is obtained from the lower-pressure stream 304 to the higher-pressure stream 311. This reduces the flow rate to compressor 307 and reduces the power required to compress stream 304. The optional heat exchangers 303, 309 cool streams 302, 308. Compressing the hydrogen stream 300 to an intermediate pressure in between the pressure of the hydrogen stream (20 atm in this example) and the pressure of the higher-pressure methane stream (100 atm in this example) increases the driving force for hydrogen permeation and increases hydrogen concentration in stream 312. As shown in FIG. 6, compressing stream 300 to intermediate pressures of 40, 50, and 60 atm is beneficial compared to the base case at 20 atm. The optimum intermediate pressure is in the range 40 to 50 atm.

### Example 5

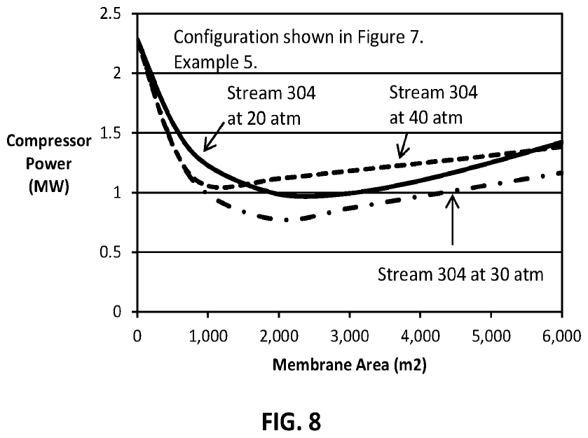

The configuration shown in FIG. 7 can also be used for the application discussed in Example 2, although the advantage is not as significant as in Example 4. In this current Example 5, the stream compositions, flow rates and pressures are the same as in Example 2, but the membrane permeances are limited to 500 gpu and 10 gpu for hydrogen and methane, respectively. FIG. 8 shows that increasing the pressure of stream 304 from 20 atm to 30 atm is advantageous because it increases the reduction in power. The maximum difference with the base case of a pressure of 20 atm occurs at a membrane area of 2,000 m² and represents a savings of about 0.2 MW. Increasing the pressure of steam 304 to 40 atm is less effective and at higher membrane areas results in a total power consumption that is higher than for the 30 atm and 20 atm cases.

### Example 6

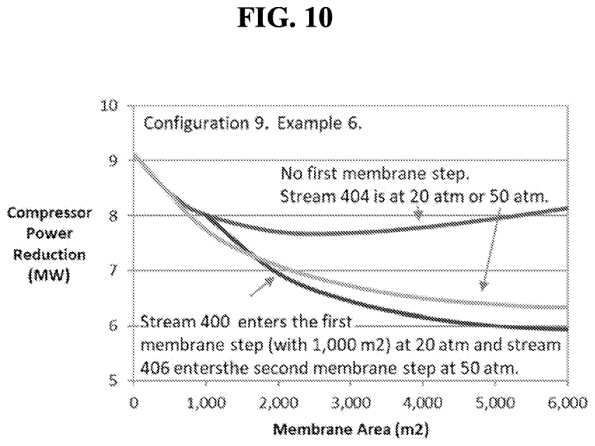

The two-step configuration shown in FIG. 9 is obtained by adding a membrane step upstream of the first compressor in the configuration shown in FIG. 7. In particular, FIG. 9 is a flow diagram for combining a gas stream 400 with a gas stream 413 at a higher pressure than stream 400 to obtain gas stream 416. The membrane permeances of the membrane in membrane devices 401 and 407 are such that a net permeation flow is obtained from the lower-pressure streams 400, 406 to the higher-pressure streams 413, 414. This reduces flow rates to compressors 403, 409. FIG. 10 shows that the additional membrane step improves the efficiency of the configuration.

### Example 7

This example is identical to Example 1 except that the combined stream is not at 100 atm but at 80 atm and the membrane selectivity for hydrogen over methane is set at 50. This means that the pressure of stream 506 in FIG. 11 has to be reduced from its starting value of 100 atm to 80 atm. This can be done efficiently with a turbine and power can be produced. As shown in the configuration of FIG. 11, the turbine can be placed either upstream or downstream of the membrane step. Placing the turbine upstream of the membrane step increases the driving force for hydrogen permeation and decreases the driving force for methane permeation. On the other hand, placing the turbine downstream of the membrane step increases the flowrate to the turbine. FIG. 11 specifically illustrates a flow diagram for combining a gas stream 500 with a gas stream 506 at a higher pressure than stream 500 to obtain a combined gas stream 512 at a pressure lower than the pressure of stream 506. The membrane permeances of the membrane in membrane device 501 are such that a net permeation flow is obtained from the lower-pressure stream 500 to the higher-pressure stream 506. This reduces the flow rates to compressor 503. As mentioned, a turbine is used to reduce the pressure of the high pressure stream. Turbine 507 can be placed upstream of the membrane step, or alternatively, turbine 510 can be placed downstream of the membrane step.

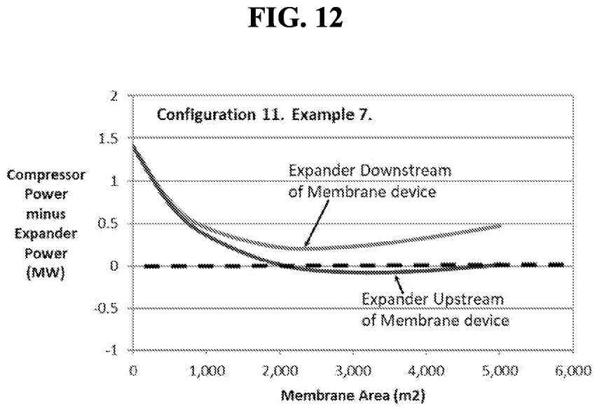

FIG. 12 shows that for this specific example placing the turbine upstream of the membrane step is most advantageous and that the process even has the potential to be a net power producer.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and processes without departing from the scope of the invention, it is intended that all matter contained in the above description and shown in the accompanying drawings shall be interpreted as illustrative and not in a limiting sense.

1. A process for the reduction of power required to combine a first gas stream at a first pressure with a second gas stream at a second pressure higher than the first pressure, thereby producing a combined third gas stream at a third pressure that is higher than the first pressure, the process comprising:
(a) contacting at least part of the first gas stream and at least part of the second gas stream in a membrane device, the membrane device comprising a first inlet port for the first gas stream, a second inlet port for the second gas stream, and first and second outlet ports, wherein the first and second gas streams are separated from one another by a gas permeable membrane, wherein the gas permeable membrane has gas permeation characteristics such that a net permeation flow is created from the first gas stream at the first pressure to the second gas stream at the second pressure, wherein the membrane device produces a high pressure exit stream and a low pressure exit stream;
(b) discharging the low pressure exit stream from the first outlet port of the membrane device, wherein the low pressure exit stream has a flow rate lower than an inlet flow rate of the first gas stream into the membrane device;
(c) combining the low pressure exit stream with any remaining portion of the first gas stream and compressing the low pressure combined stream to the third pressure;
(d) discharging the high pressure exit stream from the second outlet port of the membrane device, wherein the high pressure exit stream has a flow rate that is higher than an inlet flow rate of the second gas stream into the membrane device;
(e) combining the high pressure exit stream with any remaining portion of the second gas stream; and
(f) combining the compressed low pressure combined stream and the high pressure combined stream to produce the combined third gas stream at the third pressure.

2. The process of claim 1 wherein the first gas stream comprises hydrogen at a partial pressure greater than the hydrogen partial pressure in the second gas stream.

3. The process of claim 1 wherein the first gas stream comprises carbon dioxide at a partial pressure greater than the carbon dioxide partial pressure in the second gas stream.

4. The process of claim 1 wherein the second gas stream comprises methane at a partial pressure greater than the methane partial pressure in the first gas stream.

5. The process of claim 1 wherein the second gas stream comprises nitrogen at a partial pressure greater than the nitrogen partial pressure in the first gas stream.

6. The process of claim 1 wherein the process yields a power reduction density of at least about 10 W/m² as compared with a process of compressing the first gas stream to the second pressure to mix the first gas stream with the second gas stream at the second pressure without intervening membrane permeation of the first and second gas streams.

7-9. (canceled)

10. The process of claim 1 wherein the membrane device operates in one of a crossflow mode or a countercurrent mode.

11. (canceled)

12. The process of claim 1 wherein the membrane device has a plate-and-frame configuration, a spiral-wound configuration, or a hollow-fiber configurations.

13-14. (canceled)

15. The process of claim 1 further comprising compressing at least part of the first gas stream to a pressure lower than the third pressure prior to entering the membrane device.

16. The process of claim 1 further comprising expanding at least part of the second gas stream to the third pressure prior to entering the membrane device and optionally producing power by said expanding and using the power produce by said expanding to drive the compression steps.

17. The process of claim 1 wherein the second pressure is one of:
(I) equal to the third pressure;
(II) less than the third pressure, wherein the process further comprises compressing the high pressure combined stream; and
(III) greater than the third pressure, wherein the process further comprises expanding the high pressure combined stream before step (f).

18-19. (canceled)

20. A process for the reduction of power required to combine a first gas stream at a first pressure with a second gas stream at a second pressure, wherein the second pressure is higher than the first pressure, thereby producing a third gas stream at a third pressure higher than the first pressure, the process comprising:
(a) compressing the first gas stream to an intermediate pressure below the second pressure, and optionally heating or cooling the intermediate gas pressure stream;
(b) contacting at least part of the first gas stream at the intermediate pressure and at least part of the second stream in a membrane device, the membrane device comprising a first inlet port for the first gas stream, a second inlet port for the second gas stream, and first and second outlet ports, wherein the first and second gas streams are separated from one another by a gas permeable membrane, wherein the gas permeable membrane has gas permeation characteristics such that a net permeation flow is created from the first gas stream at the first pressure to the second gas stream at the second pressure, wherein the membrane device produces a high pressure exit stream and an intermediate pressure exit stream;
(c) discharging the intermediate pressure exit stream from the first outlet port of the membrane device, wherein the intermediate pressure exit stream has a flow rate lower than an inlet flow rate of the first gas stream into the membrane device;
(d) combining the intermediate pressure exit stream with any remaining portion of the first gas stream and compressing the intermediate pressure combined stream to the third pressure;
(e) discharging the high pressure exit stream from the second outlet port of the membrane device, wherein the high pressure exit stream has a flow rate that is higher than an inlet flow rate of the second gas stream into the membrane device;
(f) combining the high pressure exit stream with any remaining portion of the second gas stream; and
(g) combining the combined intermediate pressure stream and the combined high pressure stream to produce the third gas stream at the third pressure.

21-37. (canceled)

38. A process for combining a first gas stream with a second gas stream, the process comprising:
imparting a first gas stream at a first pressure and first flow rate into a membrane device;
imparting a second gas stream at a second pressure and second flow rate into the membrane device, the second pressure being greater than the first pressure;
permeating the first and second gas streams in a gas permeation membrane of the membrane device, wherein the gas permeation membrane is configured for net permeation flow from the first gas stream to the second gas stream;
discharging a low pressure stream and a separate high pressure stream from the membrane device after said permeating, the low pressure stream having a third flow rate less than the first flow rate and the high pressure stream having a fourth flow rate greater than the second flow rate;
compressing the low pressure stream to combine the low pressure stream with the high pressure stream.

39. The process of claim 38 wherein the first gas stream is predominantly made up of hydrogen, carbon dioxide, or a combination thereof.

40. The process of claim 38 wherein the second gas stream is predominantly made up of methane, nitrogen, or a combination thereof.

41. The process of claim 38 wherein the process yields a power reduction density of at least about 10 W/m² as compared with a process of compressing the first gas stream to the second pressure to mix the first gas stream with the second gas stream at the second pressure without intervening membrane permeation of the first and second gas streams.

42. The process of claim 38 wherein the membrane device operates in a crossflow mode or a countercurrent mode.

43. (canceled)

44. The process of claim 38 wherein the membrane device has a plate-and-frame configuration, a spiral-wound configuration, or a hollow-fiber configuration.

45-46. (canceled)

47. The process of claim 38 further comprising compressing the first gas stream from a starting pressure to the first pressure prior to imparting the first gas stream into the membrane device.

48. The process of claim 38 further comprising expanding the second gas stream from a starting pressure to the second pressure prior to imparting the second gas stream into the membrane device and optionally producing power by said expanding and using the power produced by said expanding to drive one or more compression steps.

49. The process of claim 38 further comprising expanding the first gas stream from a starting pressure to the first pressure prior to imparting the first gas stream into the membrane device.

50-51. (canceled)
